(19) United States
(12) Patent Application Publication
(10) Pub. No.: US 2019/0046867 A1
(43) Pub. Date: Feb. 14, 2019

(54) INTERACTIVE GAME CODE APPARATUS

(71) Applicant: Stu Imai, Torrance, CA (US)

(72) Inventor: Stu Imai, Torrance, CA (US)

(21) Appl. No.: 15/676,911

(22) Filed: Aug. 14, 2017

(51) Int. Cl. A63F 9/00; G06Q 30/02; A63F 13/44; A63F 13/21

(52) U.S. Cl. CPC A63F 9/0096; G06Q 30/0207; A63F 2011/0058; A63F 13/21; A63F 13/44

(57) ABSTRACT

An interactive game code apparatus resembles a battle rifle of the type used in video game depictions of combat and is able to receive a game code when the battle rifle has been successfully field stripped in a game play scenario which the battle rifle is initially assembled, followed by a first timer start input, and disassembled, followed by a first timer stop input establishing a first time interval. A second timer start input begins a second time interval during which the battle rifle is reassembled and a second timer stop input occurs marking a second time interval. If the first and second time intervals are less than a pre-determined maximum time interval, access to the game code is given.

### FIELD OF THE INVENTION

This invention relates generally to interactive games and particularly to apparatus for receiving, generating and communicating operative game codes used therein.

### BACKGROUND OF THE INVENTION

Electronic game apparatus have become extremely popular and widespread among consumers and participants in the game arts due in large part to the support provided by the dramatic developments in computer technology, low cost display systems and wireless digital communication systems and apparatus. Underlying much of this development has been the dramatic development of high-speed microprocessors and low cost high capacity memory devices. The corresponding developments of high-speed digital wireless communication has further enhanced the user-friendliness and flexibility of such systems.

The complexity and variety of video games has enjoyed a virtual explosion of expansive development fueled in large part by the above-mentioned rapid advances in the digital electronic arts. As a result, videogame consoles combine high-speed processors and high resolution color displays which facilitate highly complex and entertaining game play. Additionally, wireless communication between such game play consoles and other devices such as game play accessories, controllers and other wireless communication devices including so-called “smart phones”, computers, tablets and so-called “iPads” as further enhanced the scope and complexity of available game play. The ability of such devices to wirelessly communicate provides a multifaceted interactive capability. Users are able to interactively participate in game play employing simultaneous use of multiple devices. Thus, today's game player is able to download a game application, often called an “app” to a smart phone or tablet and play a selected game on the smart phone or tablet alone or in combination with additional apparatus. Additionally, the user of today is able to play a game on a game console and interact with other users smart phones and/or utilize various game play accessories.

Within the broad complex world of today's game play an interesting facet has emerged as game architects have introduced a variety of game codes which constitute coded words or messages that the user obtained by some means, often external to the game, which when entered into the game play unit altered the game play for that particular user. While initially generically described by the name “game codes”, such special coded words or messages also came to be known in the art by various names such as “cheat codes”, “promotional codes”, “reward codes”, and “coupon codes”. The dynamic nature of the world of game play continues to add additional names for such coded words or messages all of which are described under the generic term “game codes”.

The personal and private impression created in game players regarding game codes has prompted practitioners in the game play arts to introduce a virtually endless variety of types of game codes and system responses thereto. For example, game codes may enable the game player to achieve advancement within the game structure, such as movement to higher tiers of game play, increased strength, power or capability of the player, replenish power or ammunition or acquire some other type of game play advantage particular and private to the game player.

The commercial aspects which are ever present in the world of game play have prompted practitioners in the art to expand game codes to include parallel promotion of various products or various additional games. As a result, game codes have been created which encourage or facilitate the purchase of additional products or additional access to coupons and discounts for product purchase.

The great variety and popularity of game codes has been accompanied by a correspondingly great variety of code delivery systems. By way of example, game codes may often be obtained by purchasing certain products sponsored or promoted by the game play creators. In such case, game codes may often be purchased or otherwise obtained which solve certain game play obstacles or problems that otherwise prevent a player from succeeding to a higher game play level. In some instances game codes are published in specialized gaming publications which encourages participation and popularity among game players relating to such publications. Additionally, game codes may be available as a result of directly purchasing one or more game codes.

While the use of game codes provides substantial increase in the amusement, entertainment, challenge and reward of game play, there remains a continuing and unresolved need in the gaming arts for ever more interesting, novel and amusing game code systems and game code distribution apparatus in order to continue to challenge and engage game players.

### SUMMARY OF THE INVENTION

Accordingly, it is a general object of the present invention to provide a novel and improved game code system and delivery apparatus by which game players may obtain access to game codes. It is a more particular object of the present invention to provide a novel and improved game code system and delivery apparatus in which game players interact in a more interesting and amusing process to obtain access to game codes. It is a still more particular object of the present invention to provide a novel and improved game code system and delivery apparatus that includes game play apparatus that participates in the acquisition of game codes.

In accordance with the present invention, there is provided game code apparatus constructed of multiple components or units which may be assembled into a correct configuration to provide a properly assembled unit and which may be disassembled entirely to provide a fully disassembled unit. This capability facilitates the novel interactive game code generation and communication which involves the game player in the creation and communication of game codes in a novel manner. In the example set forth, the game code apparatus resembles a weapon in which the disassembly and reassembly of the plurality of components or units is intended to be suggestive of the military operation known generally as “field stripping” of the weapon.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth an illustrative game play system utilizing interactive game code apparatus constructed in accordance with the present invention;

FIG. 2 sets forth a side elevation view of a fully assembled interactive game code apparatus constructed in accordance with the present invention;

FIG. 3 sets forth a side elevation view of a partially sectioned fully assembled interactive game code apparatus constructed in accordance with the present invention;

FIG. 4 sets forth a partially sectioned exploded view of an interactive game code apparatus constructed in accordance with the present invention;

FIG. 5 sets forth a partially sectioned partial exploded view of an interactive game code apparatus constructed in accordance with the present invention;

FIG. 6 sets forth a partially sectioned partial assembled view of an interactive game code apparatus constructed in accordance with the present invention; and

FIGS. 7A and 7B, taken together, set forth a flow diagram illustrating the operation of the present invention interactive game code apparatus.

### DESCRIPTION OF THE PREFERRED EMBODIMENTS OF THE INVENTION

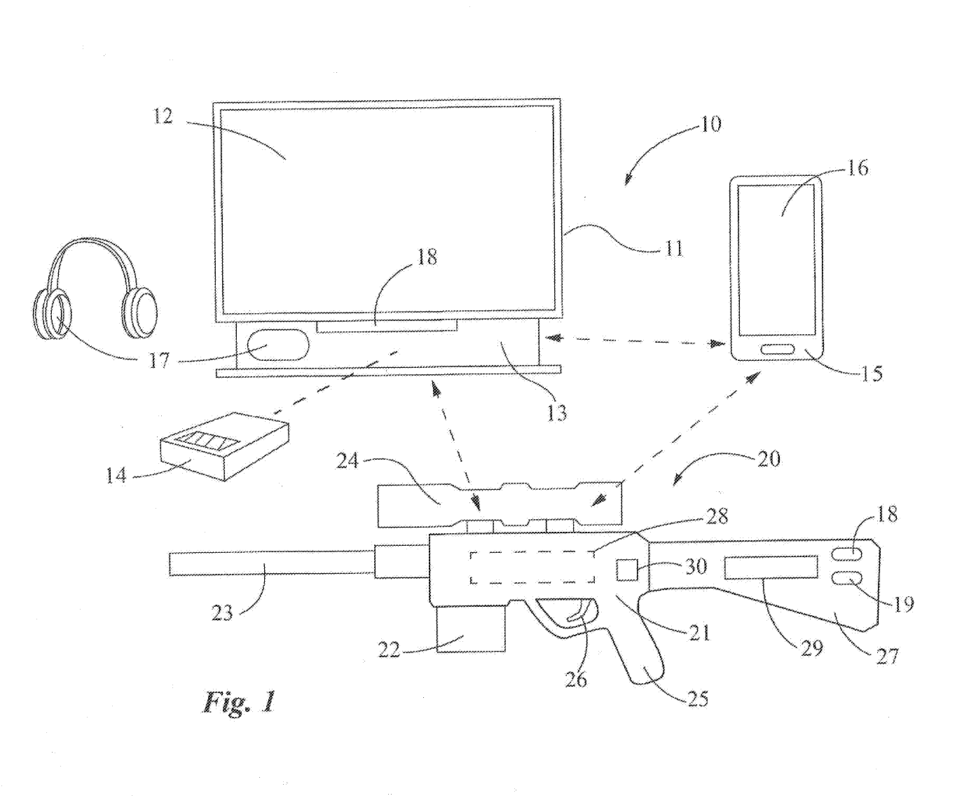

FIG. 1 sets forth an illustrative game play system, generally referenced by 10, utilizing an interactive game code apparatus, generally referenced by numeral 20, constructed in accordance with the present invention. Game code system 10 includes a game console 11 having a display 12 and a base 13. Game console 11 is conventional in fabrication and includes a base 13 supporting a conventional hardware and software game play circuit apparatus (not shown) together with a display screen 12 also of conventional fabrication. Thus, in accordance with conventional game play game console 11 is operative to carry forward the software driven operation of a video game in which successive images are produced on display screen 12 and in which player inputs are provided to participate in game play. Such player inputs may be provided by a remote game play input 14 or hands-on manipulation of a plurality of user inputs 18 supported upon base 13. In addition, base 13 supports an audio output 17 providing sound enhancement of games played by game console 11. In accordance with user preference audio output 17 may utilize a conventional speaker supported upon base 13 or alternatively may utilize a wireless headset to provide audio, and sound information to the game player. As mentioned, the fabrication and operation of game play console 11 is entirely conventional. It will be further recognized that a variety of alternative configurations for game play console 11 may be utilized without departing from the spirit and scope of the present invention.

Game code system 10 further includes a conventional smart phone 15 having a display screen 16 supported there on. Smart phone 15 is an optional device to be used or not used in the operation of system 10 as the user prefers. By way of alternative, game code system 10 may be operated using either game console 11 or smart phone 15 rather than the combined use shown in FIG. 1.

Game code system 10 further includes an interactive game code apparatus 20 which is constructed in accordance with the present invention and which is configured to replicate a simplified example of a field weapon. It will be recognized by those skilled in the art that while game code apparatus 20 is shown in the form of a field weapon, other types of weapons or other types of devices not related to weapons may be utilized in the function and manner described below in carrying forward the present invention. Thus, it will be appreciated that while a field type weapon, such as a battle rifle, is suggested by game code apparatus 20, this example is provided by way of illustration and not limitation as to the configurations which the present invention may utilize. Accordingly, game code apparatus 20 may be configured as a different type of toy or amusement device without departing from the spirit and scope of the present invention. Accordingly it will be recognized that the descriptions of structure and operations set forth below may apply equally well to differently shaped and configured toys and other apparatus without departing from the spirit and scope of the present invention.

Game code apparatus 20 includes a receiver unit 21 having a handle 25 and trigger 26 supported thereon together with a control circuit 28 supported within receiver unit 21. Game code apparatus 20 further includes a magazine unit 22 which is secured to and removable from receiver unit 21 together with a barrel unit 23 which is also secured to and removable from receiver unit 21. Game code apparatus 20 is completed by a s scope unit 24 and a stock unit 27 each secured to and removable from receiver unit 21. Stock unit 27 further supports a code display 29 which is coupled to control circuit 28 by conventional wiring means (or wireless means) (not shown).

As is set forth below in greater detail, in the preferred fabrication of the present invention the game code apparatus is constructed of multiple components or units which may be assembled into a correct configuration to provide a properly assembled unit and which may be disassembled entirely to provide a fully disassembled unit. This capability facilitates the novel interactive game code generation and communication which involves the game player in the creation and communication of game codes in a novel manner. In the example set forth in FIG. 1 and the subsequent figures below, the game code apparatus resembles a weapon in which the disassembly and reassembly of the plurality of components or units is intended to be suggestive of the military operation known generally as “field stripping” of the weapon. It will be recalled that the present invention game code apparatus is not limited to apparatus resembling a weapon but may be configured to virtually any type of toy or game play unit. Accordingly, in such event, it will be understood that the field stripping operation is woven into the game play scenario in an appropriate story creation. However, the functionality will remain the same in that the player is required to carry forward the disassembly and reassembly of the game play unit in the manner described below to obtain the game codes.

With particular attention to FIG. 1, control circuit 28 of game code apparatus 20 includes conventional wireless communication apparatus which establishes communication links to game console 11 and smart phone 15 as indicated by dashed arrows in FIG. 1. Smart phone 15 and game console 11 are also in communication by a wireless communication link indicated by dashed arrow in FIG. 1.

In operation, FIG. 1 sets forth the initial configuration for undertaking game play in accordance with the present invention in which game code apparatus 20 is fully assembled and in which there are no game codes displayed on game code displays 29, 11 and 15. By means set forth below in greater detail, game play is initiated by the game player pressing start button 18 on stock unit 27 which activates a timer within control circuit 28. The game player must then fully disassemble game code apparatus 20 by removing barrel 23, magazine 22, stock unit 27 and scope unit 24 from receiver unit 21 to provide a fully disassembled game code apparatus. Once the game player has completed disassembly of game code apparatus 20, the game player presses stop button 19 on stock unit 27 and the timer within control unit 28 stops timing. The user then initiates reassembly of game code apparatus 20 by first pressing start button 18 which initiates the timing of the timer within control circuit 28. The game player must then completely reassemble game code apparatus 20 into the fully assembled configuration and again press stop button 19 when completed.

In accordance with an alternate operation of the present invention, the above described game play may be altered to utilize a single time interval for both disassembly and reassembly of game code apparatus 20 without departing from the spirit and scope of the present invention. In this alternate game play scenario the game player begins with a fully assembled game code apparatus 20 as utilized in the previous example and by further similarity begins by pressing start button 18. In this scenario however the game player after having fully disassembled game code apparatus 20 does not press stopped button 19. Instead, the system provides a signal such as an audio beep that indicates the complete disassembly of game code apparatus 20 while the timer continues to run. Following the disassembly beep, the game player immediately undertakes to reassemble game code apparatus 20. Once game code apparatus 20 has been reassembled, the game player then presses stop button 19 and a single time interval is obtained. This time interval is then used to determine whether the game player has successfully disassembled and reassembled game code apparatus 20 in order to receive the game code or codes.

Following the completion of a time disassembly and subsequent reassembly of game code apparatus 20, the system determines whether the time intervals required for disassembly and reassembly are sufficiently fast to qualify for one or more game codes. In the event the game player has been too slow in the disassembly and reassembly process, game codes are denied and the game player must retry the entire scenario. If however, the disassembly and reassembly of game code apparatus 20 has been completed with sufficiently brief time intervals, one or more game codes are communicated to control circuit 28 for display upon game code displays 29, 15 and 11 29. The game player then enters the displayed game codes into game console 11 and a responsive change within the game play scenario is implemented. Thereafter, the game player is able to carry forward game play in accordance with the altered game scenario and enjoy the advantages of having successfully obtained the game code or codes.

In accordance with an important advantage of the present invention, registration information or a registration code may be made available either directly upon game code apparatus 20 or upon the packaging in which the game code unit is packaged. This registration code may be entered into the game play system in order to download an app specific to the players video game and game code apparatus which, when entered into the game play system, customizes or uniquely configures the game play scenario. While such registration or registration code may be provided in a variety of forms, one convenient method utilizes a so-called “QR code” such as QR code 30 which when scanned automatically inputs the full registration information and downloads the unique app for the game player. In this manner, an impression is created that the version of the game and game play resulting is completely unique and personalized thereby enhancing the game player's experience.

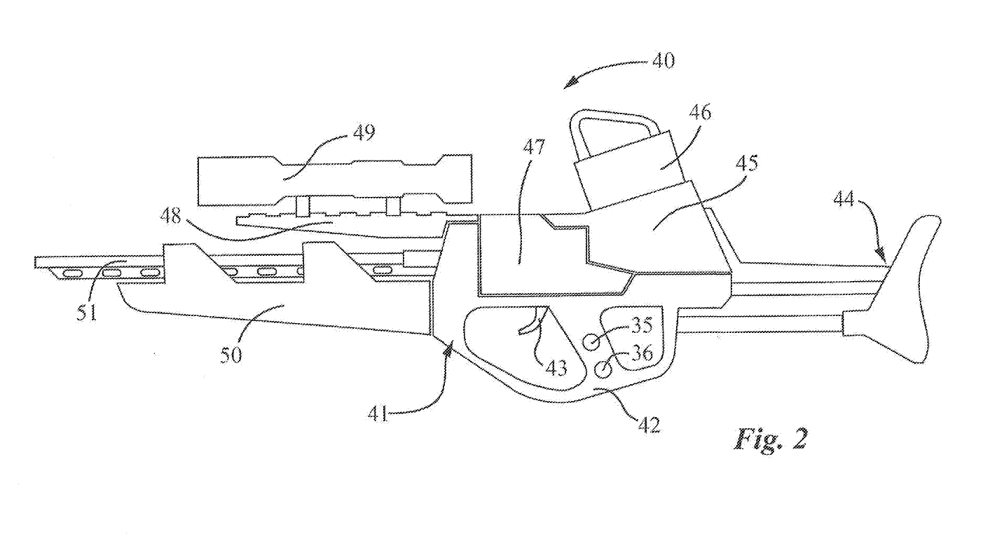

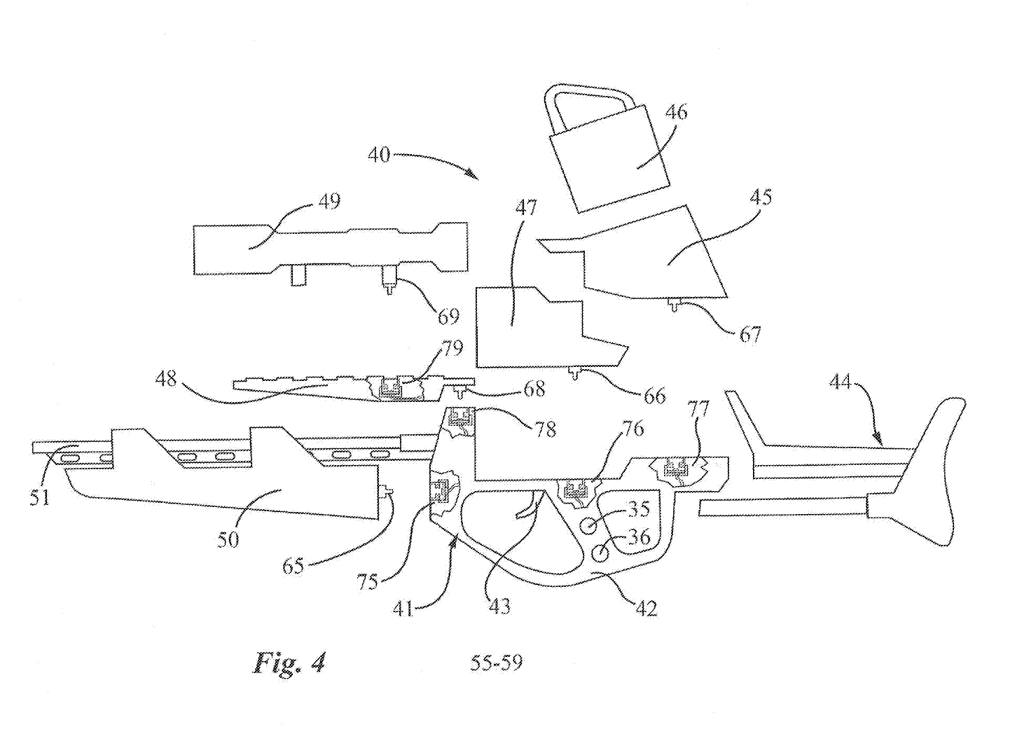

FIG. 2 sets forth a side elevation view of a game code apparatus instructed in accordance with the present invention and generally reference by 40. Game code apparatus 40 presents a more realistic depiction of a field type weapon such as a typical battle rifle or the like. Game code apparatus 40 is also suggestive of various fanciful weapons such as “blasters” or the like typically found in video games. The particular configuration of game code apparatus 40 is provided for purposes of illustration and should not be taken as limitation upon the shape which a game code apparatus may assume in a particular game scenario. The essential function of game code apparatus 40 is similar to game code apparatus 20 set forth above in FIG. 1 in that it is comprised of a plurality of interlocking units or components which may be joined to form the fully assembled configuration shown in FIG. 2 and which may be separated to form the disassembled configuration set forth below in FIG. 4.

More specifically, game code apparatus 40 includes a receiver unit 41 supporting a handle 42 and a trigger 43. Handle 42 further supports a start button 35 and a stop button 36. Game code apparatus 40 further includes a breach unit 47 joined to receiver unit 41 in the manner set forth below together with a magazine housing 45 both of which are joined to receiver unit 41. A magazine 46 is removably received with then magazine housing 45. A butt stock 44 is joined to receiver unit 41 and a barrel 51 is joined to the forward end of receiver 41. A grip 50 is positioned beneath barrel 51 and is joined to the forward end of receiver 41. An accessory rail 48 is secured to receiver unit 41 and further supports a scope 49.

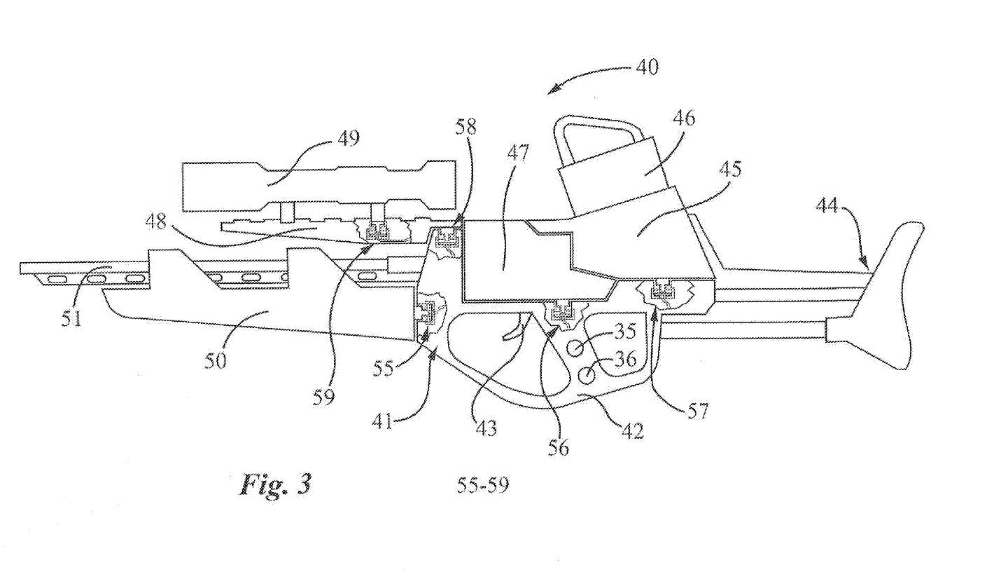

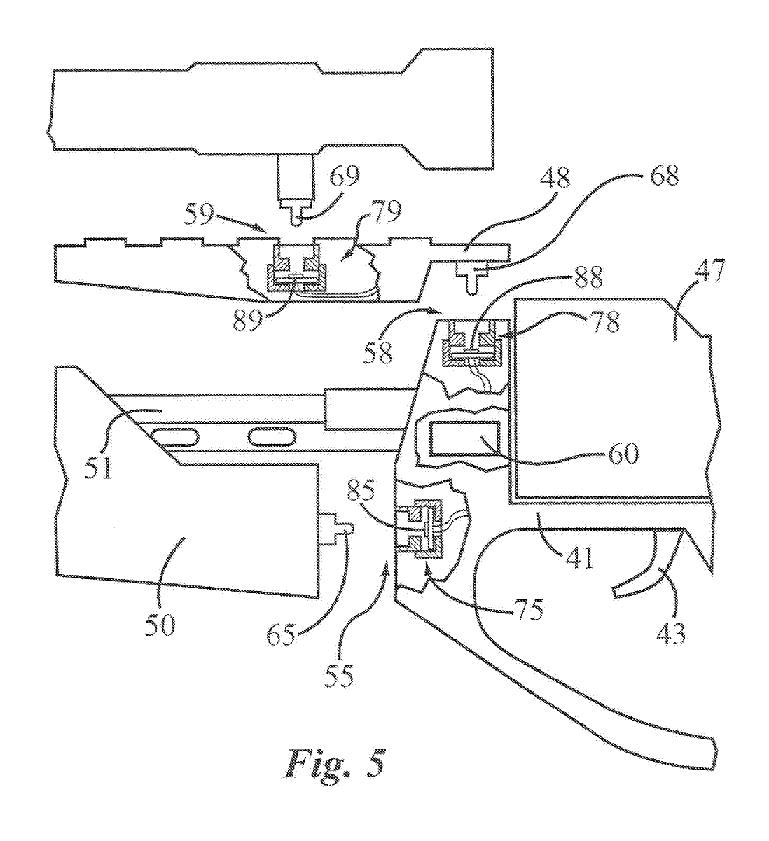

As mentioned above, game code apparatus 40 is fabricated of a plurality of removably attached units or elements which facilitate the assembly of game code apparatus 40 into the fully assembled configuration shown in FIG. 2 and the disassembly of game code apparatus 40 into the fully disassembled configuration shown in FIG. 4. It will be apparent to those skilled in the art that a variety of connecting structures may be utilized in removably securing each of the units or elements that comprise game code apparatus 40 without departing from the spirit and scope of the present invention. The essential functions of such connecting structures are forming a mechanical attachment by which the units are joined, but capable of separation, together with a “sensing contact” which provides a signal, condition to controller circuit 60 (seen in FIG. 5) indicative of the attachment or separation of the unit relative to an adjacent component or unit. Illustration is provided of such a connector arrangement in FIGS. 3 through 6 below. However, suffice it to note here that game code apparatus 40 performs its game play function by being able to sense the attachment and assembly of units to form the fully assembled configuration and, conversely, game code apparatus 40 also performs its game play function by being able to sense the separation of units to form the disassembled configuration.

FIG. 3 sets forth a partially section side elevation view of game code apparatus 40 in its fully assembled configuration. FIG. 3 also shows the locations of a plurality of connecting structures which join the respective units of game code apparatus 40 into its fully assembled configuration and which provide signal conditions indicative of their respective component connections.

More specifically, game code apparatus 40 includes a receiver unit 41 supporting a handle 42 and a trigger 43. Game code apparatus 40 further includes a breach unit 47 joined to receiver unit 41 in the manner set forth below together with a magazine housing 45 both of which are joined to receiver unit 41. A magazine 46 is removably received within magazine housing 45. A butt stock 44 is joined to receiver unit 41 and a barrel 51 is joined to the forward end of receiver 41. A grip 50 is positioned beneath barrel 51 and is joined to the forward end of receiver 41. An accessory rail 48 is secured to receiver unit 41 and further supports a scope 49.

Game code apparatus 40 includes a plurality of connecting structures 55, 56, 57, 58 and 59 which provide the above described functions of mechanical attachment and electric signal sensing of attachment for adjoining units to facilitate the above described game play. As mentioned above, each connecting structure provides a removable mechanical attachment together with an electrical signal condition which is indicative of either unit attachment or separation. For purposes of illustration game code apparatus 40 shows substantially identical connecting structures between each of the units. However, it will be apparent to those skilled in the art that a variety of different connecting structures may be utilized to meet the variations of units which form game code apparatus 40. Accordingly, connecting structure 55 joins grip 50 to the forward portion of receiver unit 41. Similarly connecting structure 56 joins breach unit 47 to receiver unit 41. Connecting structure 57 joins magazine housing 45 to receiver unit 41 while connecting structure 58 joins accessory rail 48 to receiver unit 41. Finally, connecting structure 59 joins scope 49 to accessory rail 48. In accordance with conventional fabrication techniques, connecting structures 55 through 59 will be understood to be operatively coupled to controller circuit 60 (seen in FIG. 5) using conventional wiring or wireless means (not shown). In the fully assembled configuration of game code apparatus 40 shown in FIG. 3, each of connecting structures 55 through 59 is providing a mechanical attachment between respective adjacent units and an electrical signal condition to controller circuit 60 (seen in FIG. 5) indicative of the assembled configuration.

FIG. 4 sets forth a partially section exploded view of game code apparatus 40 in its fully disassembled configuration. FIG. 4 also shows the locations of a plurality of connecting structures 55 through 59 which would normally join the respective units of game code apparatus 40 into its fully assembled configuration. In the disassembled configuration shown in FIG. 4, however, connecting structures 55 through 59 provide signal conditions indicative of their respective component separations.

More specifically, game code apparatus 40 includes receiver unit 41 supporting handle 42 and trigger 43. Game code apparatus 40 further includes breach unit 47 aligned with receiver unit 41 and magazine housing 45 both of which are aligned with receiver unit 41. Magazine 46 is removably received within magazine housing 45. Butt stock 44 is aligned with receiver unit 41 and barrel 51 is joined to the forward end of receiver 41. Grip 50 is positioned beneath barrel 51 and is aligned with the forward end of receiver 41. Accessory rail 48 is aligned with receiver unit 41 and is further aligned with scope 49.

As described above, game code apparatus 40 includes a plurality of connecting structures 55, 56, 57, 58 and 59 which provide the above described functions of mechanical attachment and electric signal sensing of attachment for adjoining units to facilitate the above described game play. As is also mentioned above, each connecting structure provides a removable mechanical attachment together with an electrical signal condition which is indicative of either unit attachment or separation. Accordingly, connecting structure 55 which normally joins handgrip 50 to the forward portion of receiver unit 41 includes a post 65 and a receptacle 75. Similarly connecting structure 56 which normally joins breach unit 47 to receiver unit 41 includes a post 66 and a receptacle 76. Connecting structure 57 which normally joins magazine housing 45 to receiver unit 41 includes a post 67 and a receptacle 77 while connecting structure 58 which normally joins accessory rail 48 to receiver unit 41 includes a post 68 and a receptacle 78. Finally, connecting structure 59 which normally joins scope 49 two accessory rail 48 includes a post 69 and a receptacle 79. In the fully disassembled configuration of game code apparatus 40 shown in FIG. 4, each of connecting structures 55 through 59 is providing an electrical signal condition to controller circuit 60 (seen in FIG. 5) indicative of the disassembled configuration.

FIG. 5 sets forth a partially sectioned partial exploded view of game code apparatus 40 in a disassembled configuration. Thus, FIG. 5 shows enlarged views of connecting structures 55, 58 and 59 in their separated configurations indicative of a disassembled configuration. Connecting structure 55 includes a receptacle 75 within which a microswitch 85 is disposed. Connecting structure 55 further includes a post 65 which is configured to be received within receptacle 75 during assembly such that the frontal end of post 65 contacts microswitch 85 producing a closed switch condition whereby connecting structure 55 is able to produce an electrical signal condition which controller circuit 60 utilizes to determine the assembly or disassembly of connecting structure 55. In the disassembled condition shown in FIG. 5, post 65 is not inserted into receptacle 75 and therefore microswitch 85 remains in an open switch condition. Similarly, connecting structure 58 includes a receptacle 78 within which a microswitch 88 is disposed. Connecting structure 58 further includes a post 68 which is configured to be received within receptacle 78 during assembly such that the frontal end of post 68 contacts microswitch 88 producing a closed switch condition whereby connecting structure 58 is able to produce an electrical signal condition which controller circuit 60 utilizes to determine the assembly or disassembly of connecting structure 58. In the disassembled condition shown in FIG. 5, post 68 is not inserted into receptacle 78 and therefore microswitch 88 remains in an open switch condition. Finally, connecting structure 59 further includes a post 69 which is configured to be received within receptacle 79 during assembly such that the frontal end of post 69 contacts microswitch 89 producing a closed switch condition whereby connecting structure 59 is able to produce an electrical signal condition which controller circuit 60 utilizes to determine the assembly or disassembly of connecting structure 59. In the disassembled condition shown in FIG. 5, post 69 is not inserted into receptacle 79 and therefore microswitch 89 remains in an open switch condition. It will be recalled that the structures of connecting structures 55 through 59 are identical and thus it will be understood that the foregoing descriptions of connecting structures 55, 58 and 59 apply with equal force to connecting structures 56 and 57.

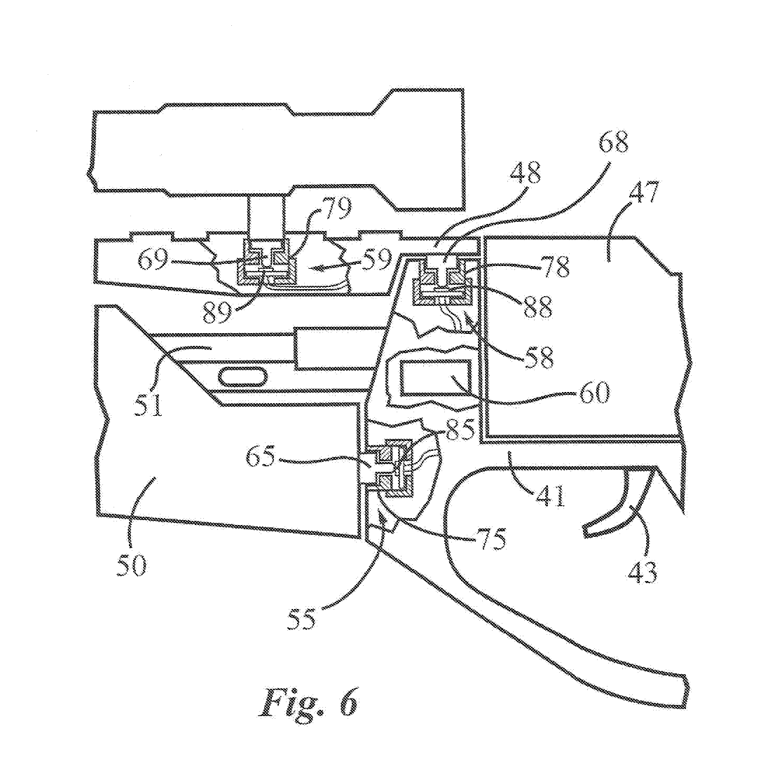

FIG. 6 sets forth a partially sectioned view of game code apparatus 40 in an assembled configuration. Thus, FIG. 6 shows enlarged views of connecting structures 55, 58 and 59 in their joined configurations indicative of an assembled configuration. Connecting structure 55 includes a receptacle 75 within which a microswitch 85 is disposed. Connecting structure 55 further includes a post 65 which is received within receptacle 75 such that the frontal end of post 65 contacts microswitch 85 producing a closed switch condition whereby connecting structure 55 is able to produce an electrical signal condition which controller circuit 60 utilizes to determine the assembly of connecting structure 55. Similarly, connecting structure 58 includes a receptacle 78 within which a microswitch 88 is disposed. Connecting structure 58 further includes a post 68 which is received within receptacle 78 during assembly such that the frontal end of post 68 contacts microswitch 88 producing a closed switch condition whereby connecting structure 58 is able to produce an electrical signal condition which controller circuit 60 utilizes to determine the assembly of connecting structure 58. Finally, connecting structure 59 further includes a post 69 which is received within receptacle 79 such that the frontal end of post 69 contacts microswitch 89 producing a closed switch condition whereby connecting structure 59 is able to produce an electrical signal condition which controller circuit 60 utilizes to determine the assembly of connecting structure 59. It will be recalled that the structures of connecting structures 55 through 59 are identical and thus it will be understood that the foregoing descriptions of connecting structures 55, 58 and 59 apply with equal force to connecting structures 56 and 57.

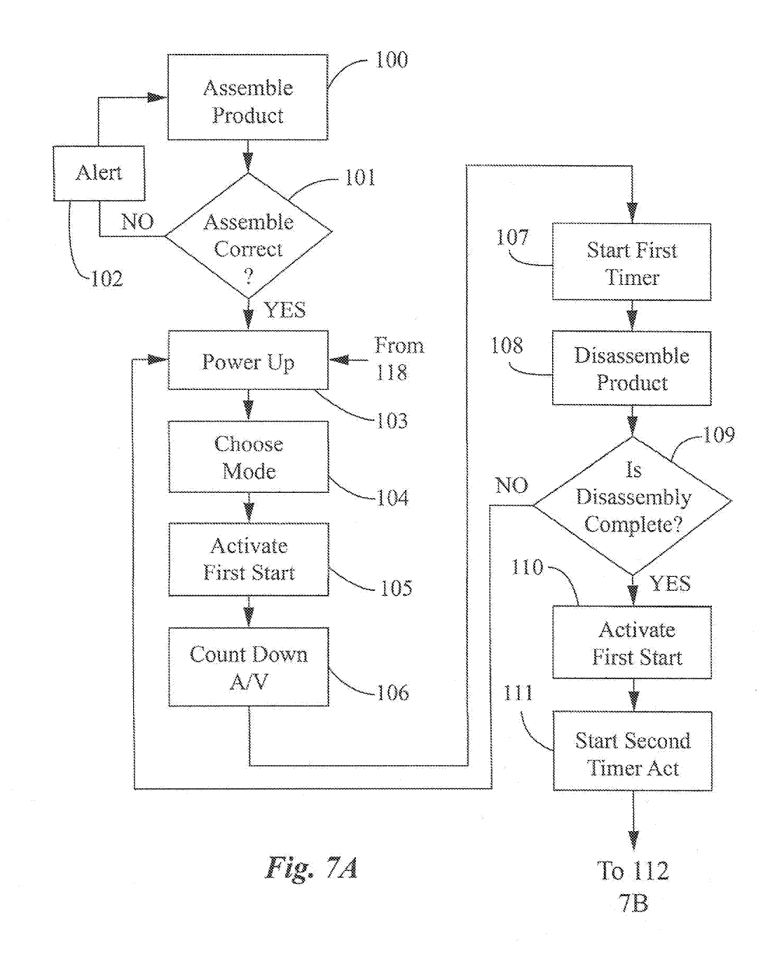

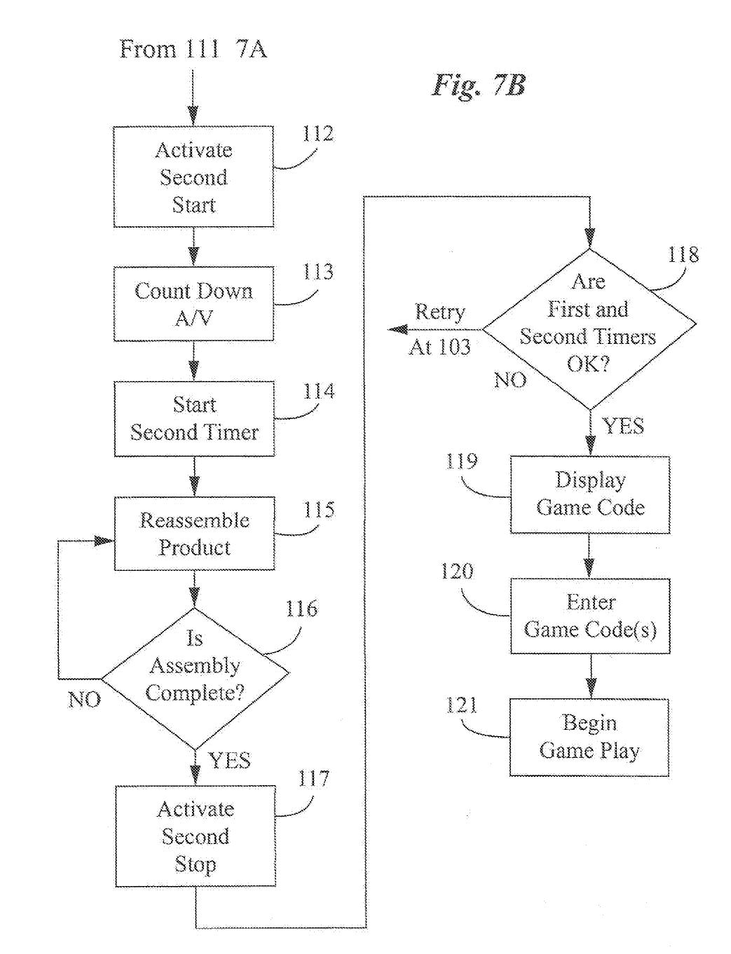

FIGS. 7A and 7B, taken together, set forth an operational flow diagram or the present invention interactive game code apparatus. System operation is initiated at a step 100 in which the product, in this case the game code apparatus, is fully assembled. At step 101 a determination is made as to whether the game control apparatus is correctly assembled. If correctly assembled, the system moves to step 103 which initiates a power up of the game console. It a determination is made that the game code apparatus is not correctly and fully assembled, the system moves to an alert step 102 indicating faulty assembly and returns to step 100. Following power up at step 103, the system moves to a step 104 in which the operating mode is selected after which the system activates the first start timer at step 105. At step 106 an audible and visual countdown indication is given to which at step 107 the first timer is automatically activated.

Once the first timer has been activated, the game player operates at step 108 to fully disassemble the game code apparatus. Following operator disassembly of the game code apparatus at step 108, a determination is made at step 109 as to whether the game code apparatus has been completely disassembled within the specified time limits. If disassembly is not complete within the specified lime limits, the system returns to step 103 and the game player again attempts to fully disassemble the game code apparatus. If a determination is made at step 109 that full disassembly has been achieved the system moves to step 110 and activates timer stop.

Once disassembly is complete and the first timer has been stopped, preparation is made to reassemble the game code apparatus. At step 111 the second start timer is prepared. At step 112 the second start is initiated and at step 113 an audio and visual countdown is given. At step 114 the second timer is automatically activated and thereafter at step 115 the game player reassembles the game code apparatus. At step 116, a determination is made as to whether the game code apparatus has been completely and correctly reassembled. If reassembly is correct and complete, the system moves to step 117 and the stop button is pressed. At step 118 the first and second time intervals are examined and, if within the specified time limits, the system moves to step 119 in which the game code, or codes, are displayed and accessible to the game player. If a determination is made at step 118 that the time intervals exceeded the allowed time interval, the system returns to step 103 for a retry. Once the game player has obtained the desired game code, or codes, at step 119, the game code, or codes, are entered into the game console at step 120 after which at step 121 the game player begins game play at the reconfigured game scenario provided in response to the game code, or codes.

In accordance with an important aspect of the present invention, the above described game play scenario by which a game player is able to obtain access to a game code or codes may be enhanced by providing a game play aspect known in the art as an “Easter egg”. Such Easter eggs provide hidden exclusive codes which the game player is able to obtain through creative alternative manipulation of the game play elements. In the present invention and by way of example the system may provide that the game player “experiment” with alternative assembly arrangements of the various components of game code apparatus 40. In the anticipated use of an Easter egg facet to game play, the game player undertakes to experiment with alternative assembly of components at the game player's risk. Thus, in most instances changing the arrangement of assembled components within game code apparatus 40 will produce a negative game play result, such as a loss of all ammunition, or similar misfortune. It is preferred that a single alternative component arrangement would have a positive and exciting result all in response to one particular alternative component arrangement. By way of example, in the reassembly of game code apparatus 40 a positive result would be limited solely to installing scope unit 49 in a reverse position. As mentioned, this facet of game play to provide an Easter egg is optional and may be undertaken to increase the game play excitement of the present invention.

In the example of the present invention given in FIGS. 1 through 6, the game code apparatus is representative of a field weapon such as an assault rifle which is known to require field stripping as part of a soldiers use, particularly during periods of combat. Accordingly the present invention game code apparatus simulates this field stripping of the game players weapon by requiring that the game code apparatus be completely disassembled and then reassembled within a specified time limit. It will be apparent to those skilled in the art that the present invention is not limited to simulation of weapon field stripping by a soldier in the field but rather illustrative of the benefits of the present invention. In response to the game play provided by the present invention system and apparatus, a unique and here to for unrealized apparatus and method for a game player to acquire game codes is provided.

As will be apparent to those skilled in the art, the above described examples of embodiments of the present invention utilizing game weapons of a basic structure is fully adequate for illustrating the operation of the present invention. It will be recognized however that the present invention may readily utilize game weapons having additional qualities and capabilities of the type often found in existing game technologies to provide further excitement and enhance game play. For example, the invention may utilize game weapons such as those with capabilities of shooting projectiles such as foam darts, plastic BB's, pellets, balls or paint projectiles. By further example the game weapon utilized in carrying forward the invention may include electronic magazines which provide interchangeable magazines for use with indoor play and rely upon infrared “shooting” rather than other projectile weapons such as plastic BBs or other projectiles. In many instances such infrared type weapons are used in association with responsive targets that transform or change game play.

While particular embodiments of the invention have been shown and described, it will be obvious to those skilled in the art that changes and modifications may be made without departing from the invention in its broader aspects. Therefore, the aim in the appended claims is to cover all such changes and modifications as fall within the true spirit and scope of the invention.

That which is claimed is:

1. For use in combination with a video game play device, an interactive game code apparatus comprising:
a plurality of units assembled into a combined apparatus having a configuration characterized as a correctly assembled apparatus and separated into a separated apparatus having a configuration characterized as a fully disassembled apparatus;
a plurality of connecting structures supported upon said units each of said connecting structures including a cooperating mechanical attachment and a connection indicator, said cooperating mechanical attachments securing said plurality of units in said combined apparatus;
a controller circuit being coupled to said plurality of connection indicators and having means for receiving a game code and transmitting a game code; and
a timer responsive to a timer start input and a timer stop input such that a timer start input followed by a timer stop input produces a time interval between said timer start input and said timer stop input,
said interactive game code apparatus receiving a game code when said plurality of units is initially assembled into said combined apparatus having a configuration characterized as a correctly assembled apparatus, followed by a first timer start input, and disassembly of said plurality of units, followed by a first timer stop input establishing a first timer interval, followed by a second timer start input, followed by a reassembly of said plurality of units into said combined apparatus having a configuration characterized as a correctly assembled apparatus followed by a second timer stop input establishing a second timer interval, wherein said first and second timer intervals are less than a pre-determined maximum time interval.

2. The interactive game code apparatus set forth in claim 1 wherein said plurality of units include portions of a game weapon.

3. The interactive game code apparatus set forth in claim 2 wherein said game weapon is shaped to resemble a battle weapon.

4. For use in combination with a video game play device, an interactive game code apparatus having an appearance resembling a battle rifle for simulating the process of field stripping the battle rifle and thereby receive access to one or more game codes, said interactive game code apparatus comprising:
a plurality of battle rifle components assembled into an assembled battle rifle having a configuration characterized as a correctly assembled battle rifle and separated into a field stripped battle rifle;
a plurality of connecting structures supported upon said battle rifle components each of said connecting structures including a cooperating mechanical attachment and a connection indicator, said cooperating mechanical attachments securing said plurality of battle rifle components in said battle rifle;
a controller circuit being coupled to said plurality of connection indicators and having means for receiving a game code; and
a timer responsive to a timer start input and a timer stop input such that a timer start input followed by a timer stop input produces a time interval between said timer start input and said timer stop input,
said interactive game code apparatus receiving a game code when said battle rifle has been successfully field stripped in a game play scenario in which said battle rifle is initially assembled, followed by a first timer start input, and disassembly of said plurality of battle rifle components, followed by a first timer stop input establishing a first time interval, followed by a second timer start input, followed by a reassembly of said battle rifle, followed by a second timer stop input establishing a second time interval, wherein said first and second time intervals are less than a pre-determined maximum time interval.

5. For use in combination with a video game play device, an interactive game code apparatus having a first configuration exhibiting an assembled appearance and a second configuration exhibiting a disassembled appearance for simulating the process of disassembling and assembling the interactive game code apparatus and thereby receive access to one or more game codes, said interactive game code apparatus comprising:
a plurality of components assembled into said first configuration characterized as a correctly assembled game code apparatus and separated into a second configuration characterized as fully disassembled;
a plurality of connecting structures supported upon said components each of said connecting structures including a cooperating mechanical attachment and a connection indicator, said cooperating mechanical attachments securing said plurality of components;
a controller circuit being coupled to said plurality of connection indicators and having means for receiving a game code; and
a timer responsive to a timer start input and a timer stop input such that a timer start input followed by a timer stop input produces a time interval between said timer start input and said timer stop input,
said interactive game code apparatus receiving a game code when said interactive game code apparatus has been successfully manipulated in a game play scenario in which said initially assembled components are sequentially disassembled and reassembled during a time interval initiated by a timer start input followed by a timer stop input wherein said time interval is less than a pre-determined maximum time interval.

6. The interactive game code apparatus set forth in claim 5 wherein said plurality of components form a game weapon.

7. The interactive game code apparatus set forth in claim 6 wherein said plurality of components form a game weapon having a timer start button and a timer stop button supported thereon.

8. The interactive game code apparatus set forth in claim 7 wherein said plurality of components form a game weapon having a game code display supported thereon.

9. The interactive game code apparatus set forth in claim 5 wherein said game play scenario includes an alert indicator following said disassembly indicating a complete disassembly of said game code apparatus.
